(19) United States
(12) Patent Application Publication
(10) Pub. No.: US 2018/0364722 A1
(43) Pub. Date: Dec. 20, 2018

(54) ROAD HAZARD DETECTION

(71) Applicant: Microsoft Technology Licensing, LLC, Redmond, WA (US)

(72) Inventors: Benny SCHLESINGER, Ramat Hasharon (IL); Shira WEINBERG, Tel Aviv (IL)

(21) Appl. No.: 15/625,027

(22) Filed: Jun. 16, 2017

(51) Int. Cl. G05D 1/02; G08G 1/0967

(52) U.S. Cl. CPC G05D 1/0214; G08G 1/0967

(57) ABSTRACT

Implementations described herein disclose a road hazard detection method including receiving a plurality of mobile device sensor signals from one or more sensors located on a mobile device within a vehicle, determining the road hazard encountered by the vehicle by analyzing the plurality of mobile device sensor signals, and reporting the existence of the road hazard to other users. In one implementation, the road hazard detection method also uses sensor signals from various sensors located on the vehicle and/or sensor signals from mobile devices of users on other vehicles to determine the road hazard.

### BACKGROUND

Drivers are often surprised by unexpected road hazards and need to take evasive actions at the last moment, risking their own safety and the safety of others. Having information about road hazards in advance may also affect drivers' routing decisions such as avoiding certain roads. Furthermore, vehicle technology is fast moving towards self-driving vehicles. Such self-driving vehicles need accurate and timely information to provide better navigation and traffic management.

### SUMMARY

Implementations described herein disclose a road hazard detection method including receiving a plurality of mobile device sensor signals from one or more sensors located on a mobile device within a vehicle, determining the road hazard encountered by the vehicle by analyzing the plurality of mobile device sensor signals, and reporting the existence of the road hazard to other users. In one implementation, the road hazard detection method also uses sensor signals from various sensors located on the vehicle and/or sensor signals from mobile devices of users on other vehicles to determine the road hazard.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

A further understanding of the nature and advantages of the present technology may be realized by reference to the figures, which are described in the remaining portion of the specification. In the figures, like reference numerals are used throughout several figures to refer to similar components.

FIG. 1 illustrates an example implementation of a system for providing detection and reporting of road hazards.

FIG. 2 illustrates an alternative implementation of a system for providing detection and reporting of road hazards.

FIG. 3 illustrates an example vehicle environment and a module for providing detection and reporting of road hazards.

FIG. 4 illustrates example operations for providing automatic detection of road hazards.

FIG. 5 illustrates alternative example operations for providing automatic detection of road hazards.

FIG. 6 illustrates an example system that may be useful in implementing the described technology for providing automatic detection of road hazards.

FIG. 7 illustrates an example mobile device that may be useful in implementing the described technology for providing automatic detection of road hazards.

### DETAILED DESCRIPTIONS

A road hazard detection (RHD) system disclosed herein allows automatic detection of road hazards using signals collected in a vehicle, such as a car, a plane, a boat, etc. Specifically, the RHD system disclosed herein determines hazards on a navigation path using signals collected from various mobile devices of users in such vehicle. For example, the RHD system may determine that a hazard exists on a road on which a car is traveling by collecting and analyzing signals from various sensors on the smartphones of the users in that car. For example, if a traffic lane is blocked due to an accident, forcing all drivers to slow down and switch lanes, the RHD system identifies the pattern of slowing down and switching lanes to infer existence and nature of the hazard. The RHD system may also alert other drivers and the authorities of the existence and the nature of the hazard. Implementations of the RHD system also combine the signals collected from mobile devices of the users with other signals from sensors located on the vehicle or signals collected from users on other vehicles.

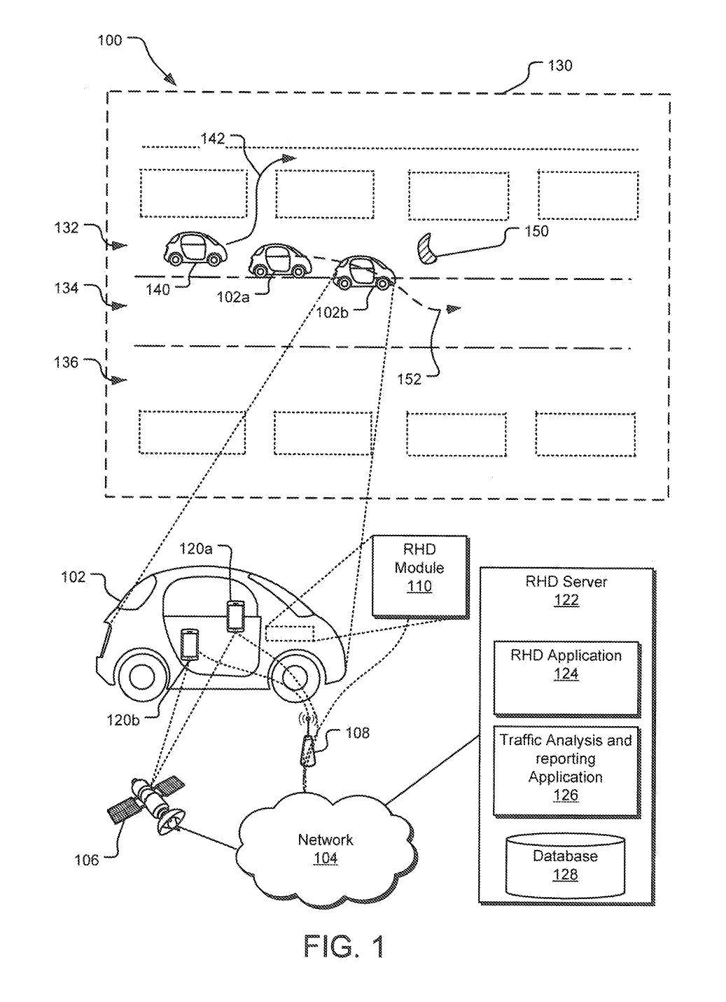

FIG. 1 illustrates an example implementation of a RHD system 100 for providing detection and reporting of road hazards. The RHD system 100 is illustrated in context of a mapped area 130 including traffic lanes 132, 134, 136. The mapped area 130 is shown to have a vehicles 102 and 140 traveling on traffic lane 132. Specifically, the vehicle 102 is illustrated at two different locations by 102a and 102b. As illustrated, the traffic lane 132 has a hazard 150, such as a pothole, which causes the vehicle 102 to change its current traffic lane, traffic lane 132, to the adjacent traffic lane, traffic lane 134. This is represented by the movement 152 of the vehicle 102 across the traffic lanes 132 and 134. In an alternative implementation, the hazard 150 may be a fallen tree limb, a broken-down vehicle, an accident, a bump in the road, etc. In other implementations, for vehicles traveling on water or in air, the hazard 150 may be an air turbulence, a tornado funnel, a high wave, etc.

An expanded view of the vehicle 102 shows that the vehicle 102 has passengers having mobile devices 120a and 120b (hereinafter referred to as mobile devices 120). For example, such mobile devices 120 may be smartphones, tablets, user health monitoring devices such as a smart-watch, etc. The mobile devices 120 may have various sensors such as an accelerometer, a gyroscope, a proximity sensor, a digital compass, an ambient light sensor, etc. The vehicle 102 also has a RHD module 110 that is able to communicate with various mobile devices 120.

As the vehicle 102 moves from the traffic lane 132 to the traffic lane 134, one or more of the sensors of the mobile devices 120 generate signals in response to such move. For example, if the vehicle 120 switches the traffic lanes suddenly, the accelerometers on the mobile devices 120 generate a signal indicating acceleration in the direction orthogonal to the traffic lanes. Similarly, in response to the change of angle for the vehicle 102, the compass of the mobile devices 120 generate signals indicting change in the direction of the travel. In one implementation, the mobile devices 120 may include an app that collects such signals and communicates them to the RHD module.

The RHD module 110 collects the signals from the mobile devices 120 and analyzes them to determine if the signals indicate a change in the vehicle 102's navigation pattern. For example, the RHD module 110 may analyze the accelerometer signals from each of the mobile devices 120 to determine that the signals from each of the mobile devices 120 are substantially similar to each other indicating the sudden change in the navigation pattern of the vehicle 102. However, if only the accelerometer signal from mobile device 120a is showing a movement while the accelerometer signal from the mobile device 120b is not present, the RHD module 110 may conclude that such signal may be movement caused by the user of mobile device 120a that is unrelated to any change in the navigation pattern of the vehicle 102. Thus, the RHD module 110 is able to determine that vehicle 192 has encountered a road hazard. Furthermore, the analysis of the magnitude of change of the navigation pattern may identify the nature of the road hazard as well.

For example, if the hazard 150 is a bump in the road, accelerometers of the devices 120 detect a sudden change in acceleration along the Z-axis (substantially orthogonal to the surface of the mapped area 130). Based on detection of such signals, the RHD module 110 may determine the hazard 150 to be a bump in the road. In another implementation of the RHD system 100, the signals collected by the RHD module 110 may also include visual signal such as signals collected from a dashboard camera of the vehicle 102. In such an implementation, the nature of the hazard may be identified by analyzing such visual signals. However, mere detection of the hazard 150 is valuable even when the RHD system does not determine the nature of the hazard 150.

In an implementation of the RHD system 100 upon detection of a road hazard, the RHD module 110 reaches out to the users via the mobile devices 120 with notification of the hazard. For example, the RHD module 110 may send a notification via a text message, a message in an application installed on the mobile devices 120, etc., and asks the users to identify the nature of the hazard 150 so that the detection and nature of the hazard 150 can be shared with other users, authorities, etc.

In another example, if the vehicle 102 ends up traveling over the hazard 150 without changing the traffic lanes, this may cause generation of an accelerometer signal in a vertical direction. The RHD module 110 may identify such signals to determine the nature of the hazard to be a pothole.

The RHD system 100 also includes a geographic positioning signal (GPS) satellite 106 and a wireless tower 108 that are communicatively connected to the mobile device 120 and to the RHD module 110. Specifically, the GPS satellite 106 may be connected to the GPS receivers of the mobile devices 120 and a GPS receiver of the vehicle 102. The wireless tower 108 may communicatively connect the mobile devices 120 and the RHD module 110 to a network 104 such as the Internet.

An RHD server 122 may be communicatively connected to the network 104. The RHD server 122 may be implemented on one computing device, on a plurality of computing devices, on a cloud environment, etc. In one implementation, the RHD server 122 may include an RHD application 124 in form of a plurality of instructions stored on a computer readable memory. The RHD application 124 may communicate with the RHD module 110 to collect road hazard data from various vehicles and to alert other vehicles, users, authority, etc., about the existence and nature of road hazards.

The RHD server 122 may also include a traffic analysis and reporting module 126 that uses the road hazard information and other traffic related information to analyze traffic and communicate with various navigation systems such as various mobile device based mapping applications, various autonomous vehicle driving systems, etc. A database 128 of the RHD server 122 stores the information about the road hazards and the traffic. For example, upon collecting information about the hazard 150 on traffic lane 132, the traffic analysis and reporting module 126 may communicate to a vehicle 140 or a user of the vehicle 140 to inform them about the potential of slow traffic due to the existence of the pothole and may recommend an alternative route 142 to the vehicle 140. Alternatively, the traffic analysis and reporting module 126 may merely communicate existence of the hazard 150 to a mapping and/or navigation application on a mobile device of a user on the vehicle 140.

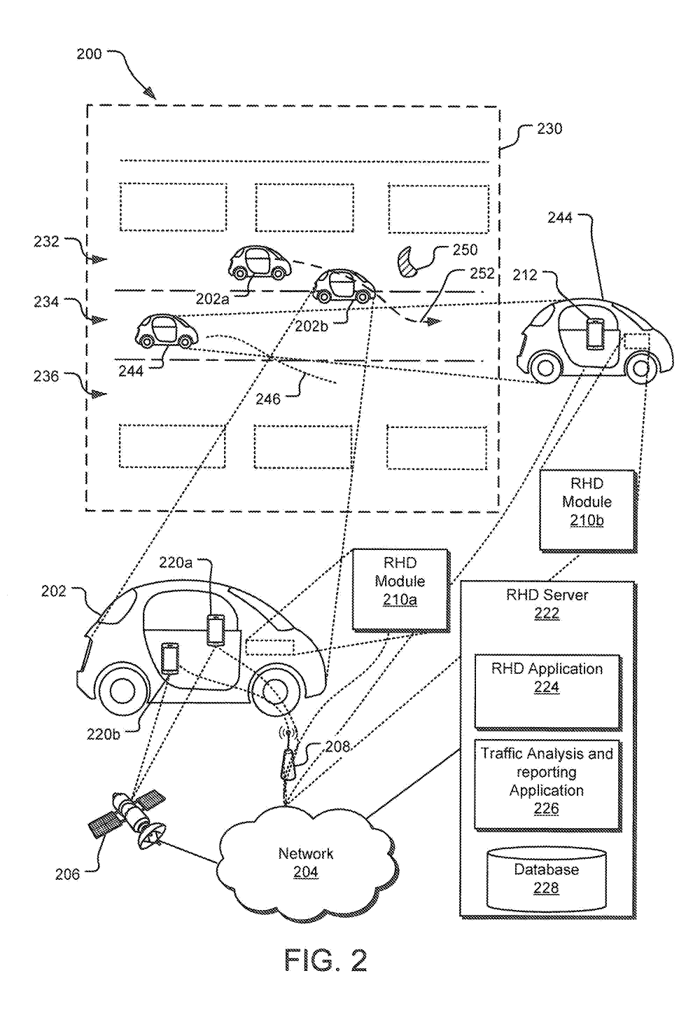

FIG. 2 illustrates an alternative implementation of a RHD system 200 for providing detection and reporting of road hazards. The RHD system 200 is illustrated in context of a mapped area 230 including three traffic lanes 232, 234, 236. The mapped area 230 includes vehicle 202 travelling on traffic lane 232 (as shown by 202a) and moving to the traffic lane 234 in response to detecting a road hazard 250 (as shown by 202b). The road hazard may be pot hole, an accident, a broken-down vehicle, etc. The change in the direction of the vehicle 202 from the traffic lane 232 to the traffic lane 234 is illustrated by the movement 252. The movement 252 may be detected by analyzing signals from one or more sensors located on the mobile devices on the vehicle 202.

The mapped area 230 is also illustrated to include other vehicles, including a vehicle 244 traveling in the traffic lane 234. In response to the detection of the vehicle 202, and potentially other vehicles in the mapped area 230, moving from traffic lane 232 to the traffic lane 234, the vehicle 244 also changes its direction of travel from traffic lane 234 to the traffic lane 236, as represented by the movement 246. The movement 246 may be determined by analyzing signals from one or more sensors located on the mobile devices on the vehicle 244.

Each of the vehicles 202 and 244 includes a RHD module, respectively 210a and 210b (referred to as the RHD modules 210). The RHD modules 210 may be communicatively connected to various sensors on the vehicles 202, 244 as well as with various sensors on mobile devices in the vehicles 202, 244. Specifically, the vehicle 202 has users with mobile devices 220a, 220b (referred to as mobile devices 220), such as smartphones, tablets, etc. The vehicle 244 has a user with a mobile device 212. The mobile devices 212, 220 may communicate with a GPS satellite 206 to get GPS information, and with a wireless tower 208 to communicate to a network 204, such as the Internet. Similarly, the RHD modules 210 may also be configured to communicate with the network 204 via the wireless tower 208.

The mobile devices 212, 220 may have various sensors such as an accelerometer, a gyroscope, a proximity sensor, a digital compass, an ambient light sensor, etc. In one implementation, the RHD modules 210 communicate with the mobile devices 212, 220 using an application installed on the mobile devices 212, 220. The RHD modules 210 may collect various signals from various sensors located on the mobile devices 212, 220 and communicate these signals to an RHD server 222 that is also communicatively connected with the network 204. Alternatively, the RHD modules 210 may analyze the signals collected from the various sensors on the mobile devices 212, 220, determine existence and nature of a road hazard 250 encountered by the vehicles 202, 224, and communicate information about such existence and nature of the road hazard 250 encountered by the vehicles 202, 224 to the RHD server 222.

The RHD server 222 includes an RHD application 224, a traffic analysis and reporting module 226, and a database 228. In one implementation, the RHD application 224 collects the sensor signals communicated by the RHD modules 210 from various vehicles and processes them to determine existence and nature of a road hazard in the mapped area 230. For example, if an accelerometer signal from the RHD module 210 indicates movement of the vehicle 202 towards traffic lane 234 and an accelerometer signal from the RHD module 210a indicates movement of the vehicle 244 towards traffic lane 236, the RHD application 224 may determine that there is a road hazard in traffic lane 232. Furthermore, the RHD application 224 may also combine the sensor signals received from the RHD modules 210 with GPS signals from the mobile devices 212, 220 to further confirm the existence of the road hazard. Thus, the RHD system 200 incorporates sensor signals from mobile devices on various vehicles in the mapped area 230 to determine the existence and nature of the road hazard 250.

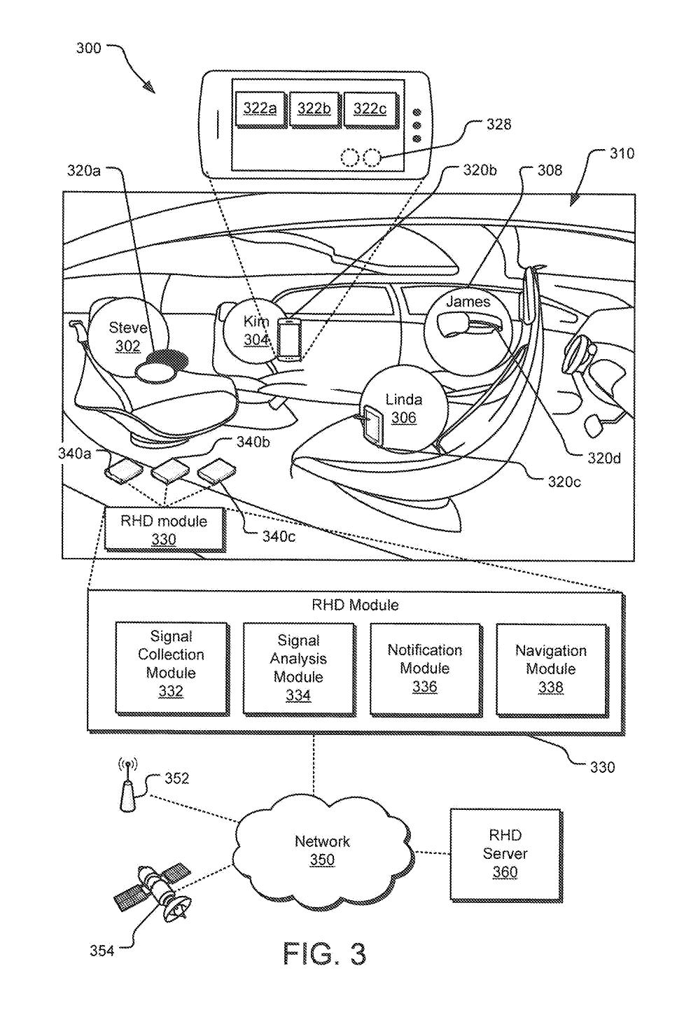

FIG. 3 illustrates an example vehicle environment 300 and a RHD module 330 for providing detection and reporting of road hazards. Specifically, the vehicle environment 300 is illustrated to be in a vehicle 310 having various users 302, 304, 306, and 308. The vehicle 310 may be, for example, a car, a boat, an airplane, etc. Each of these users 302-308 may have a mobile device. For example, the user 302 has a mobile watch 320a, the user 304 has a mobile phone 320b, the user 306 has a tablet 320c, and the user 308 has a virtual reality (VR) headset 320d. Each of these mobile devices 320a, 320b, 302c, and 302d (referred to herein as mobile devices 320) has one or more sensors. For example, such sensors may include an accelerometer, a gyroscope, a proximity sensor, a digital compass, etc., the generate signals in response to the movement of the respective mobile device 320.

The vehicle 310 also includes a RHD module 330 that is communicatively connected to the mobile devices 320. For example, the RHD module 330 may be communicatively connected to the mobile devices 320 using a Bluetooth communication link, a WiFi communication link, etc. The mobile devices 320 may have an application that collects the data from the sensors on the device and communicates such sensor data to the RHD module 330. For example, the mobile phone 320b may have an RHD app 322a that periodically collects sensor signals from an accelerometer 328 on the mobile phone 320b and communicates the signal to the RHD module 330. In one implementation, such an RHD app 322a may also communicate with other applications on the mobile device 320b, such as a navigation app 322b, a mapping app 322c, etc.

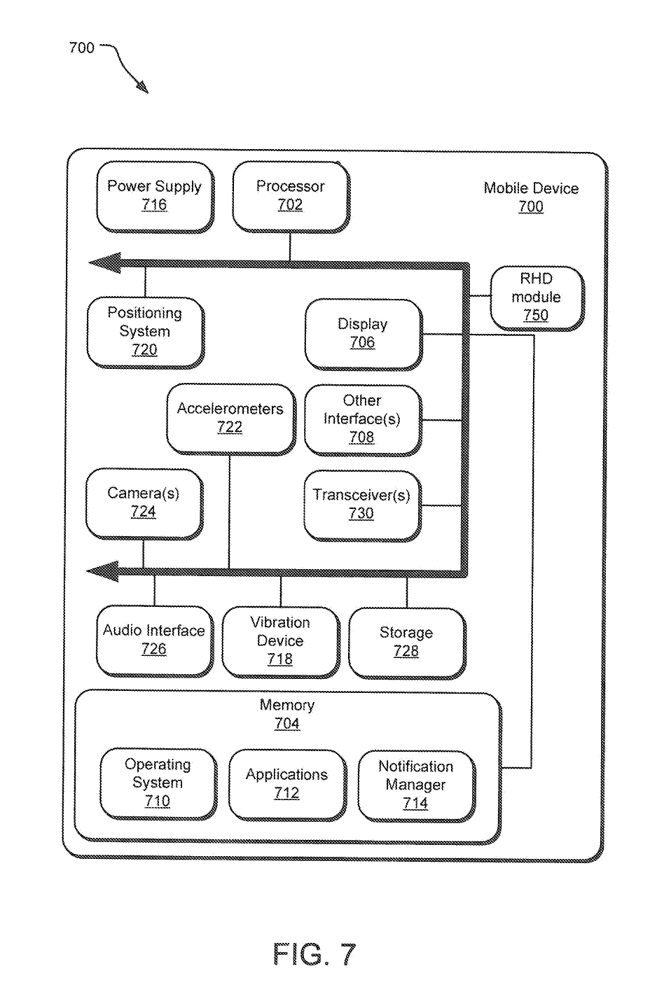

The RHD app 322a may be implemented using computer instructions that are processes by a processor of the mobile phone 320b (such as the processor 702 disclosed in FIG. 7). In one implementation, the RHD app 322a sends a sensor signal to the RHD module 330 when the change in the sensor signal is significant. For example, if the vehicle 310 comes across a road hazard and in response to the road hazard, the path or speed of the vehicle 310 changes relatively abruptly, such change in the path or speed of the vehicle 310 results in an instantaneous change in the signal generated by the accelerometer 328. The RHD app 322a compares the magnitude of the signal from the accelerometer 328 to a predetermined threshold level and if the accelerometer signal is above such a predetermined threshold, it communicates the signal to the RHD module 330.

In an alternative implementation, the RHD app 322a communicates the sensor signal from the accelerometer 328 in response to a request from the RHD module 330. For example, if the RHD module 330 has received a signal from the tablet 320c indicating a change in a sensor signal, the RHD module 330 may request other mobile devices 320 in the vehicle 310 to send the sensor signals for a predetermined time period. In such a case, the mobile device 320b sends the collected signals from the accelerometer 328 for the predetermined time period.

The RHD module 330 includes a signal collection module 332 that collects sensor signals from the mobile devices 320. Furthermore, the signal collection module 332 may also collect sensor signals from other sensors located on the vehicle 310. For example, the vehicle 310 may have an accelerometer 340a, a gyroscope 340b, and a compass 340c, (referred to as sensors 340) that generate signals based on movement of the vehicle. The RHD module 330 may be connected to such sensors 340 wirelessly or by wired connections.

The RHD module 330 also includes a signal analysis module 334 that analyzes the collected signals from the sensors 340 and the mobile devices 320 to determine existence and nature of road hazard for the vehicle 310. For example, if the vehicle were an airplane, the signal analysis module 334 may analyze the sensor signals to conclude presence of a clear-air-turbulence (CAT). For example, such presence of a CAT may be based on determining that an average of the gyro signals from the mobile devices 320 and the sensors 340 is above a predetermined threshold.

The RHD module 330 also includes a notification module 336 that communicates with an RHD server 360 to notify the RHD server 360 of the existence and nature of the hazard in path of the vehicle 310. The notification module 336 may communicate with the RHD server 360 via a network 350, such as the Internet that is also connected to a wireless tower 352 and a GPS satellite 354. A navigation module 338 of the RHD module 330 may alter navigation of the vehicle 310 in response to determination of the existence and nature of the hazard.

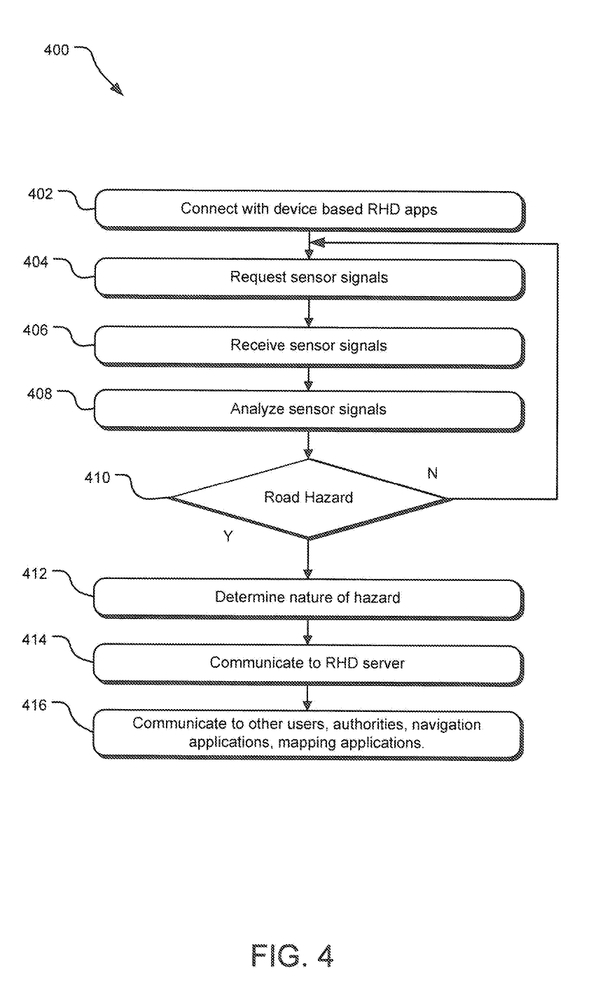

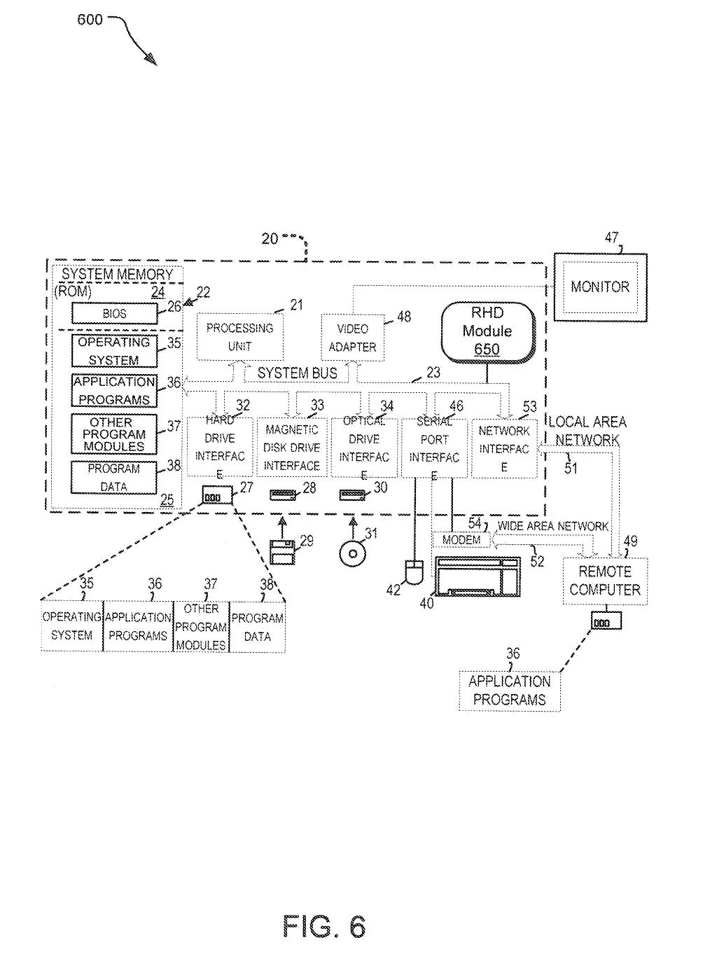

FIG. 4 illustrates example operations 400 for providing automatic detection of road hazards. Operations 400 may be implemented on an RHD module on a vehicle (such as the RHD modules 110, 210, 310 disclosed in FIGS. 1-3). Specifically, one or more of the operations 400 may be implemented using software instructions that are stored on memory (such as the memory 22 of FIG. 6) and executed by a processor (such as the processing unit 21 of FIG. 6). An operation 402 initiates communication with various applications based on mobile devices, such as smartphones, tablets, etc. In one implementation, the operation 402 is initiated once it is determined that the vehicle is in motion. Furthermore, the operation 402 may be initiated with each mobile device after establishing a communication connection with such mobile device.

An operation 404 requests sensor signals from the mobile devices. In one implementation, the sensor signals are requested to be provided on a periodic basis. Alternatively, the operation 404 may request the sensor signals from the mobile devices when a substantial change in a mobile signal is detected. For example, the operation 404 may communicate a threshold value for a sensor signal and instruct the mobile device to communicate the sensor signal when the measured sensor signal is above the threshold. An operation 404 receives the sensor signals from the mobile devices. For example, such sensor signals may be signals from an accelerometer, a signal from a gyro device, etc. Furthermore, the operation 404 may also receive sensor signals from sensors located on the vehicle, such as an accelerometer located on the vehicle, a sensor attached to a shock absorber of the vehicle, a speedometer of the vehicle, etc.

An operation 408 analyzes the sensor signals received from the mobile devices. An example analysis may be to determine an average of a threshold signal and to compare the average with a predetermined threshold. For example, when implemented on an RHD module of an airplane, the operation 408 may determine average of gyro signals from each of the mobile devices on the passenger and compare the average gyro signal to a threshold gyro signal representing CAT. Using the results of the analysis, an operation 410 determines if the vehicle has encountered a road hazard.

If it is determined that the vehicle has encountered a road hazard, an operation 412 determines the nature of the road hazard. For example, the operation 412 may analyze the sensors from a mobile device indicating a sudden movement in z-direction for the vehicle above a predetermined value to conclude that the vehicle as just passed over a pothole on a road. An operation 414 communicates the existence and nature of the road hazard to a RHD server. At an operation 416 the RHD server may communicate the information about the existence and nature of the road hazard to other users, various other mobile devices, authorities, a navigation application server, various other autonomous or semi-autonomous vehicles, etc.

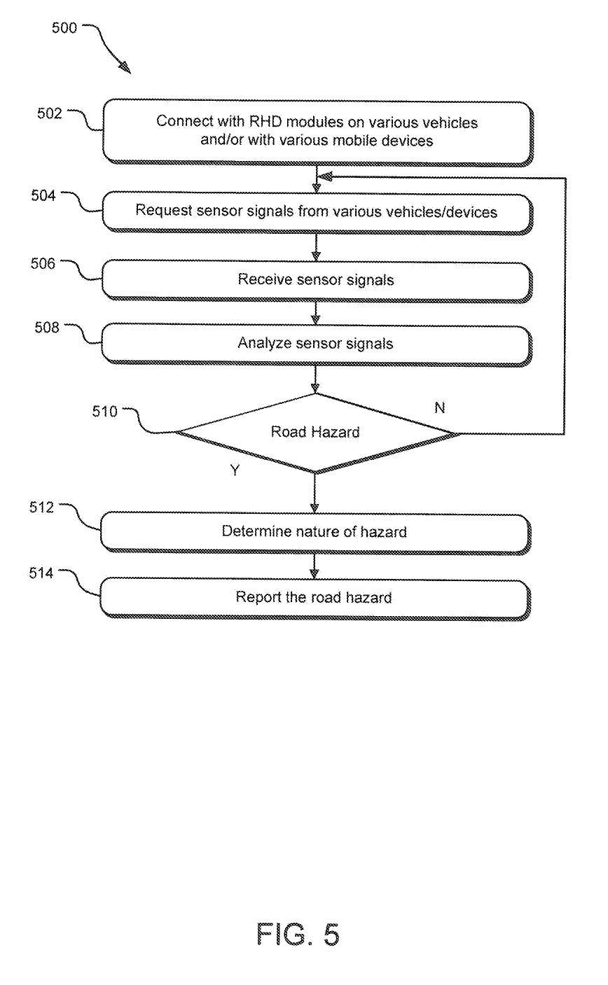

FIG. 5 illustrates alternative example operations 500 for providing automatic detection of road hazards. Operations 500 may be implemented on an RHD server (such as the RHD server 122, 222, 360 disclosed in FIGS. 1-3). Specifically, one or more of the operations 500 may be implemented using software instructions that are stored on memory (such as the memory 22 of FIG. 6) and executed by a processor (such as the processing unit 21 of FIG. 6).

An operation 502 establishes communication with various RHD modules resident on various vehicles (such as the RHD modules 110, 210, 310 disclosed in FIGS. 1-3) and/or with various mobile devices (such as the mobile devices 120, 220, 320 disclosed in FIGS. 1-3). An operation 504 requests sensor signals from various RHD modules resident of the vehicles and various mobile devices. An operation 506 receives the sensor signals and an operation 508 analyzes the sensor signals. For example, the operation 508 may assign mobile devices to vehicles based on the GPS coordinates of the mobile devices and the vehicles before analyzing the sensor signals. Furthermore, the operation 508 may also assign mobile devices and vehicles to specific areas based on vicinity of the mobile devices and the vehicles to each other.

Based on the analysis of the sensor signals coming from the same vehicle and/or vehicles in vicinity of each other, an operation 510 determines existence of one or more road hazards in various locations. When a road hazard is identified, an operation 512 optionally determines the nature of the road hazard based on analysis of the sensor signals and an operation 514 reports the existence and/or the nature of the various road hazards. Note that even when the nature of the road hazard is not determined, the reporting of the existence of the road hazard by the operation 514 allows other users, authorities, etc., to take appropriate action in response to the knowledge about the existence of the road hazard. For example, the operation 514 may report the existence and nature of the various road hazards to a traffic authority, to various users subscribing to services of the RHD module, to various navigation and mapping applications, etc.

FIG. 6 illustrates an example system 600 that may be useful in implementing the image rendition system disclosed herein. The example hardware and operating environment of FIG. 6 for implementing the described technology includes a computing device, such as a general-purpose computing device in the form of a computer 20, a mobile telephone, a personal data assistant (PDA), a tablet, smart watch, gaming remote, or other type of computing device. In the implementation of FIG. 6, for example, the computer 20 includes a processing unit 21, a system memory 22, and a system bus 23 that operatively couples various system components including the system memory to the processing unit 21. There may be only one or there may be more than one processing unit 21, such that the processor of a computer 20 comprises a single central-processing unit (CPU), or a plurality of processing units, commonly referred to as a parallel processing environment. The computer 20 may be a conventional computer, a distributed computer, or any other type of computer; the implementations are not so limited.

In the example implementation of the computing system 600, the computer 20 also includes a RHD module 650 providing one or more functions of the image rendition operations disclosed herein. The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read-only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The computer 20 may be used to implement a signal sampling module configured to generate sampled signals based on the reflected modulated signal 72 as illustrated in FIG. 1. In one implementation, a frequency unwrapping module including instructions to unwrap frequencies based on the sampled reflected modulations signals may be stored in memory of the computer 20, such as the read-only memory (ROM) 24 and random access memory (RAM) 25, etc.

Furthermore, instructions stored on the memory of the computer 20 may be used by a system for delivering personalized user experience. Similarly, instructions stored on the memory of the computer 20 may also be used to implement one or more operations of a personalized user experience delivery system disclosed herein.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide nonvolatile storage of computer-readable instructions, data structures, program modules and other data for the computer 20. It should be appreciated by those skilled in the art that any type of tangible computer-readable media may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may generate reminders on the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device or other common network node, and typically includes many or all of the elements described above relative to the computer 20. The logical connections depicted in FIG. 5 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local area network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are examples and other means of communications devices for establishing a communications link between the computers may be used.

In an example implementation, software or firmware instructions for requesting, processing, and rendering mapping data may be stored in system memory 22 and/or storage devices 29 or 31 and processed by the processing unit 21. Mapping data and/or layer prioritization scheme data may be stored in system memory 22 and/or storage devices 29 or 31 as persistent data-stores. A RHD module 650 communicatively connected with the processing unit 21 and the memory 22 may enable one or more of the capabilities of the personalized user experience delivery system disclosed herein.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

FIG. 7 illustrates another example system (labeled as a mobile device 700) that may be useful in implementing the described technology. The mobile device 700 includes a processor 702, a memory 704, a display 706 (e.g., a touchscreen display), and other interfaces 708 (e.g., a keyboard). The memory 704 generally includes both volatile memory (e.g., RAM) and non-volatile memory (e.g., flash memory). An operating system 710, such as the Microsoft Windows® Phone operating system, resides in the memory 704 and is executed by the processor 702, although it should be understood that other operating systems may be employed.

One or more application programs 712 are loaded in the memory 704 and executed on the operating system 710 by the processor 702. Examples of applications 712 include without limitation email programs, scheduling programs, personal information managers, Internet browsing programs, multimedia player applications, etc. A notification manager 714 is also loaded in the memory 704 and is executed by the processor 702 to present notifications to the user. For example, when a promotion is triggered and presented to the shopper, the notification manager 714 can cause the mobile device 700 to beep or vibrate (via the vibration device 718) and display the promotion on the display 706.

The mobile device 700 includes a power supply 716, which is powered by one or more batteries or other power sources and which provides power to other components of the mobile device 700. The power supply 716 may also be connected to an external power source that overrides or recharges the built-in batteries or other power sources.

The mobile device 700 includes one or more communication transceivers 730 to provide network connectivity (e.g., mobile phone network, Wi-Fi®, BlueTooth®, etc.). The mobile device 700 also includes various other components, such as a positioning system 720 (e.g., a global positioning satellite transceiver), one or more accelerometers 722, one or more cameras 724, an audio interface 726 (e.g., a microphone, an audio amplifier and speaker and/or audio jack), and additional storage 728. Other configurations may also be employed.

In an example implementation, a mobile operating system, various applications, and other modules and services may be embodied by instructions stored in memory 704 and/or storage devices 728 and processed by the processing unit 702. User preferences, service options, and other data may be stored in memory 704 and/or storage devices 728 as persistent datastores. A RHD module 750 communicatively connected with the processor 702 and the memory 704 may enable one or more of the capabilities of the personalized user experience delivery system disclosed herein.

The road hazard identification system disclosed herein provides a solution to a technological problem necessitated by the increased use of navigation applications and mapping applications by users of manual, autonomous, and/or semi-autonomous vehicles. Specifically, the road hazard identification system disclosed herein provides an unconventional technical solution to this technological problem by automatically determining the existence and nature of road hazards by analyzing sensor signals from mobile devices.

A road hazard detection system disclosed herein provides a method including receiving a plurality of mobile device sensor signals from one or more sensors located on a mobile device within a vehicle and determining existence of a road hazard encountered by the vehicle by analyzing the plurality of mobile device sensor signals. In one implementation, the method further includes receiving a plurality of sensor signals from one or more sensors located on the vehicle, wherein determining the road hazard encountered by the vehicle further comprises analyzing the plurality of sensor signals from one or more sensors located on the vehicle together with the plurality of mobile device sensor signals. In another implementation, the plurality of mobile device sensor signals includes a gyro signal from the mobile device within the vehicle. In an alternative implementation, the plurality of mobile device sensor signals includes an accelerometer signal from the mobile device within the vehicle.

In one implementation of the method, the mobile device within the vehicle is a mobile device of a user in the vehicle. Alternatively, the mobile device within the vehicle is at least one of a smartphone, a smart-watch, a tablet, and a virtual reality headset. Yet alternatively, the method further includes determining a nature of the road hazard by analyzing the plurality of mobile device sensor signals. In one implementation, determining the existence of a road hazard encountered by the vehicle further comprising determining an average value of a particular type of sensor signals and comparing the average value to a predetermined threshold. Yet alternatively, the method further includes reporting of the existence of the road hazard to at least one of authorities, navigational application, and users on the vehicle, and other users.

A physical article of manufacture including one or more tangible computer-readable storage media, encoding computer-executable instructions for executing on a computer system a computer process, the computer process including receiving a plurality of mobile device sensor signals from one or more sensors located on a mobile device within a vehicle and determining existence of a road hazard encountered by the vehicle by analyzing the plurality of mobile device sensor signals. In one implementation, the computer-executable instructions further include receiving a plurality of sensor signals from one or more sensors located on the vehicle, wherein determining the road hazard encountered by the vehicle further comprises analyzing the plurality of sensor signals from one or more sensors located on the vehicle together with the plurality of mobile device sensor signals. In an alternative implementation, the computer-executable instructions further includes receiving a plurality of sensor signals from one or more sensors located mobile devices vehicles other than the vehicle, wherein determining the road hazard encountered by the vehicle further comprises analyzing the plurality of sensor signals from one or more sensors located on the vehicle together with the plurality of mobile device sensor signals from one or more sensors located on mobile devices on vehicles other than the vehicle.

In another implementation, the plurality of mobile device sensor signals includes at least one of a gyro signal from the mobile device within the vehicle, an accelerometer signal from the mobile device within the vehicle, and a compass signal from the mobile device within the vehicle. Yet alternatively, wherein the computer-executable instructions further include determining a nature of the road hazard by analyzing the plurality of mobile device sensor signals. Alternatively, the mobile device within the vehicle is at least one of a smartphone, a smart-watch, a tablet, and a virtual reality headset.

A road hazard detection system disclosed herein includes a memory, one or more processor units, one more mobile devices within a vehicle, each of the one or more mobile devices including one or more sensors, and a road hazard detection (RHD) module stored in the memory and executable by the one or more processor units, the RHD module configured to receive a plurality of mobile device sensor signals from the one or more sensors located on mobile devices within the vehicle and to determine existence of a road hazard encountered by the vehicle by analyzing the plurality of mobile device sensor signals. In one implementation, the RHD module is further configured to receive a plurality of sensor signals from one or more sensors located on the vehicle and determine the road hazard encountered by the vehicle by analyzing the plurality of sensor signals from the one or more sensors located on the vehicle together with the plurality of mobile device sensor signals.

In an alternative implementation, the one or more sensors includes an accelerometer, a gyroscope, and a compass. Alternatively, the one more mobile devices within the vehicle are one or more user mobile devices.

The above specification, examples, and data provide a complete description of the structure and use of exemplary embodiments of the invention. Since many implementations of the invention can be made without departing from the spirit and scope of the invention, the invention resides in the claims hereinafter appended. Furthermore, structural features of the different embodiments may be combined in yet another implementation without departing from the recited claims.

What is claimed is:

1. A method comprising:
receiving a plurality of mobile device sensor signals from one or more sensors located on a mobile device within a vehicle; and
determining existence of a road hazard encountered by the vehicle by analyzing the plurality of mobile device sensor signals.

2. The method of claim 1, further comprising receiving a plurality of sensor signals from one or more sensors located on the vehicle, wherein determining the road hazard encountered by the vehicle further comprises analyzing the plurality of sensor signals from one or more sensors located on the vehicle together with the plurality of mobile device sensor signals.

3. The method of claim 1, wherein the plurality of mobile device sensor signals includes a gyro signal from the mobile device within the vehicle.

4. The method of claim 3, wherein the plurality of mobile device sensor signals includes an accelerometer signal from the mobile device within the vehicle.

5. The method of claim 1, wherein the mobile device within the vehicle is a mobile device of a user in the vehicle.

6. The method of claim 1, wherein the mobile device within the vehicle is at least one of a smartphone, a smart-watch, a tablet, and a virtual reality headset.

7. The method of claim 1, further comprising determining a nature of the road hazard by analyzing the plurality of mobile device sensor signals.

8. The method of claim 1, wherein determining the existence of a road hazard encountered by the vehicle further comprising determining an average value of a particular type of sensor signals and comparing the average value to a predetermined threshold.

9. The method of claim 1, further comprising reporting of the existence of the road hazard to at least one of authorities, navigational application, and users on the vehicle, and other users.

10. A physical article of manufacture including one or more tangible computer-readable storage media, encoding computer-executable instructions for executing on a computer system a computer process, the computer process comprising:
receiving a plurality of mobile device sensor signals from one or more sensors located on a mobile device within a vehicle; and
determining existence of a road hazard encountered by the vehicle by analyzing the plurality of mobile device sensor signals.

11. The physical article of manufacture of claim 10, wherein the computer-executable instructions further comprising receiving a plurality of sensor signals from one or more sensors located on the vehicle, wherein determining the road hazard encountered by the vehicle further comprises analyzing the plurality of sensor signals from one or more sensors located on the vehicle together with the plurality of mobile device sensor signals.

12. The physical article of manufacture of claim 11, wherein the computer-executable instructions further comprising receiving a plurality of sensor signals from one or more sensors located mobile devices vehicles other than the vehicle, wherein determining the road hazard encountered by the vehicle further comprises analyzing the plurality of sensor signals from one or more sensors located on the vehicle together with the plurality of mobile device sensor signals from one or more sensors located on mobile devices on vehicles other than the vehicle.

13. The physical article of manufacture of claim 10, wherein the plurality of mobile device sensor signals includes at least one of a gyro signal from the mobile device within the vehicle, an accelerometer signal from the mobile device within the vehicle, and a compass signal from the mobile device within the vehicle.

14. The physical article of manufacture of claim 10, wherein the computer-executable instructions further comprising determining a nature of the road hazard by analyzing the plurality of mobile device sensor signals.

15. The physical article of manufacture of claim 10, wherein the mobile device within the vehicle is at least one of a smartphone, a smart-watch, a tablet, and a virtual reality headset.

16. A system for detecting road hazards, comprising:
memory;
one or more processor units;
one more mobile devices within a vehicle, each of the one or more mobile devices including one or more sensors; and
a road hazard detection (RHD) module stored in the memory and executable by the one or more processor units, the RHD module configured to receive a plurality of mobile device sensor signals from the one or more sensors located on mobile devices within the vehicle, to determine existence of a road hazard encountered by the vehicle by analyzing the plurality of mobile device sensor signals, and to determine the nature of the road hazard by analyzing the magnitude of the change in at least one of the plurality of mobile device sensor signals.

17. The system of claim 16, wherein the RHD module is further configured to receive a plurality of sensor signals from one or more sensors located on the vehicle and determine the road hazard encountered by the vehicle by analyzing the plurality of sensor signals from the one or more sensors located on the vehicle together with the plurality of mobile device sensor signals.

18. The system of claim 16, wherein the one or more sensors includes an accelerometer, a gyroscope, and a compass.

19. The system of claim 16, wherein the one more mobile devices within the vehicle are one or more user mobile devices.

20. The system of claim 16, wherein the one more mobile devices within the vehicle includes at least one of a smartphone, a smart-watch, a tablet, and a virtual reality headset.
